(19) United States
(12) Patent Application Publication
(10) Pub. No.: US 2022/0414719 A1
(43) Pub. Date: Dec. 29, 2022

(54) USER FEEDBACK FOR PRODUCT RATINGS

(71) Applicant: Hewlett-Packard Development Company, L.P., Spring, TX (US)

(72) Inventors: Anuradha Kulkarni, Pune (IN); Narendra Kumar Chincholikar, Pune (IN); Akanksha Dadheech, Pune (IN)

(21) Appl. No.: 17/850,747

(22) Filed: Jun. 27, 2022

(30) Foreign Application Priority Data
Jun. 28, 2021 (IN) 202141028913

(51) Int. Cl. G06Q 30/02; G06Q 30/06; H04L 51/02; G06N 20/00

(52) U.S. Cl. CPC G06Q 30/0282; G06Q 30/0631; G06Q 30/0623; G06Q 30/0201; H04L 51/02; G06N 20/00

(57) ABSTRACT

In one example in accordance with the present disclosure, an electronic device is described. An example electronic device includes a processor and memory storing executable instructions that when executed cause the processor to import user feedback for a product from multiple websites. The instructions also cause the processor to combine the user feedback with product health data for the product. The instructions further cause the processor to run a machine-learning (ML) model to determine a rating for the product based on the combined user feedback and product health data. In some examples, the instructions also cause the processor to implement a chatbot to receive a user query and provide a product recommendation based on the user feedback and product rating.

### BACKGROUND

Electronic technology has advanced to become virtually ubiquitous in society and has been used to improve many activities in society. For example, electronic devices are used to perform a variety of tasks, including work activities, communication, research, and entertainment. Different varieties of electronic circuits may be utilized to provide different varieties of electronic technology.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of an electronic device to generate product ratings based on user feedback, according to an example.

FIG. 2 is a block diagram illustrating a system for generating a product rating based on user feedback, according to an example.

FIG. 3 is a block diagram illustrating a recommendation engine, according to an example.

FIG. 4 is a block diagram illustrating a chatbot, according to an example.

FIG. 5 depicts a non-transitory machine-readable storage medium for generating a product recommendation based on classified user feedback, according to an example.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Websites may be used to collect and publish user feedback on products that a user has used. For example, upon purchasing a product from an ecommerce website (e.g., Amazon®, Best Buy®, HP Store®, etc.), a user may leave feedback about the product. In other examples, a user may use websites other than the one used to purchase the product to leave feedback. For instance, a user may leave feedback on video sharing platforms (e.g., YouTube®, etc.) or social media sites (e.g., Facebook®, Instagram®, TikTok®, etc.).

In some examples, a user may provide both positive feedback and negative feedback. In the case of an electronic device (e.g., a laptop computer, desktop computer, smartphone, etc.), a user may describe features about the electronic device that the user enjoys and other aspects of the electronic device that the user does not like. For example, a user may rave about the display qualities of a tablet computer, but may complain about the short battery life of the same tablet computer.

Organizations that produce and sell electronic devices may use many Business-to-Consumer (B2C) websites for marketing and sales of their devices (e.g., laptops, desktops, printers, monitors, and accessories). In some examples, a manufacturer may perform product evaluation and testing before launch of a product. However, a product may fail when customers start using them. When customers realize that they have purchased a product that does not meet their expectations, then the customers may start giving negative feedback on a B2C website or other website. Negative feedback directly impacts the brand value of a manufacturer. Negative feedback may also drive away prospective buyers, which impacts planned revenue and the overall success of a product.

Having insight into user feedback may aid in the continuing development of a product. For example, negative feedback may provide a manufacturer valuable insight into how to enhance and redesign their products. Positive feedback may confirm that product features are valued by users. With knowledge of both positive and negative feedback, a manufacturer may make informed decisions about the directions of product development.

However, for a given product, monitoring multiple websites for user feedback is an arduous task for people. For example, a person would have to enter search criteria in multiple websites to find relevant reviews. That person would then have to read through the reviews to determine whether there is positive or negative feedback. This process would be time consuming and expensive to perform. Furthermore, the time and expense would be compounded for multiple products or versions of products.

The examples described herein provide for an artificial intelligence-based approach to continuously import user feedback and ratings for a product. In these examples, data about the health of the product may be stored to correlate customer feedback with the performance of the product. In some examples, a machine-learning (ML) model may be trained to identify positive and negative user feedback. The ML model may then generate a rating for the product based on the user feedback.

In some examples, a report may be generated based on the rating of the product. For example, an email may be sent to the product development manager that includes a report about the positive and negative feedback. In some examples, the top positive and top negative feedback may be provided in the report. In some examples, summarized recommendations may be provided for each product-to-product manager to implement customer feedback and build a competitive product. Using these examples, predictions for product sales may be made based on changes made to a product to address the user feedback.

In some examples, a chatbot using the processed user feedback may be implemented. For example, a user may post questions regarding product performance. The chatbot may provide a real-time answer based on other user feedback and product health data. The chatbot may help a user (e.g., a customer) by suggesting the best product to meet their indicated criteria based on other user feedback.

The present specification describes examples of an electronic device. The electronic device includes a processor. In this example, the processor is to import user feedback for a product from multiple websites. The processor may combine the user feedback with product health data for the product. The processor may also run an ML model to determine a rating for the product based on the combined user feedback and product health data.

In another example, the present specification also describes an electronic device. The electronic device includes a processor. In this example, the processor is to import user feedback for a product from a website. The processor is to combine the user feedback with product health data for the product. The processor is to run an ML model to determine a number of top positive user feedback and a number of top negative user feedback for the product based on the combined user feedback and product health data. The processor is also to generate a report based on the top positive user feedback and the top negative user feedback.

In yet another example, the present specification also describes a non-transitory machine-readable storage medium that includes instructions, when executed by a processor of an electronic device, cause the processor to receive user feedback for multiple products from a website. The instructions also cause the processor to receive product health data for the multiple products. The instructions further cause the processor to combine the user feedback with product health data for a given product based on identity information for the given product. The instructions additionally cause the processor to run an ML model to classify the user feedback for the multiple products based on the combined user feedback and product health data. The instructions also cause the processor to generate a product recommendation based on the classified user feedback.

As used in the present specification and in the appended claims, the term “processor” may be a controller, an application-specific integrated circuit (ASIC), a semiconductor-based microprocessor, a central processing unit (CPU), and a field-programmable gate array (FPGA), and/or other hardware device.

As used in the present specification and in the appended claims, the term “memory” may include a computer-readable storage medium, which computer-readable storage medium may contain, or store computer-usable program code for use by or in connection with an instruction execution system, apparatus, or device. The memory may take many types of memory including volatile and non-volatile memory. For example, the memory may include Random Access Memory (RAM), Read Only Memory (ROM), optical memory disks, and magnetic disks, among others. The executable code may, when executed by the respective component, cause the component to implement the functionality described herein.

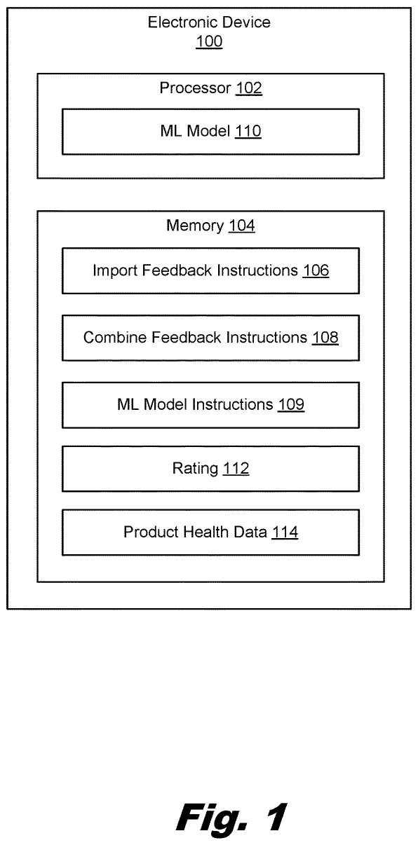

Turning now to the figures, FIG. 1 is a block diagram of an electronic device 100 to generate product ratings from user feedback, according to an example. As described above, the electronic device 100 includes a processor 102, The processor 102 of the electronic device 100 may be implemented as dedicated hardware circuitry or a virtualized logical processor. The dedicated hardware circuitry may be implemented as a central processing unit (CPU). A dedicated hardware CPU may be implemented as a single to many-core general purpose processor. A dedicated hardware CPU may also be implemented as a multi-chip solution, where more than one CPU are linked through a bus and schedule processing tasks across the more than one CPU.

A virtualized logical processor may be implemented across a distributed computing environment. A virtualized logical processor may not have a dedicated piece of hardware supporting it. Instead, the virtualized logical processor may have a pool of resources supporting the task for which it was provisioned. In this implementation, the virtualized logical processor may be executed on hardware circuitry; however, the hardware circuitry is not dedicated. The hardware circuitry may be in a shared environment where utilization is time sliced. Virtual machines (VMs) may be implementations of virtualized logical processors.

In some examples, a memory 104 may be implemented in the electronic device 100. The memory 104 may be dedicated hardware circuitry to host instructions for the processor 102 to execute. In another implementation, the memory 104 may be virtualized logical memory. Analogous to the processor 102, dedicated hardware circuitry may be implemented with dynamic random-access memory (DRAM) or other hardware implementations for storing processor instructions. Additionally, the virtualized logical memory may be implemented in an abstraction layer which allows the instructions to be executed on a virtualized logical processor, independent of any dedicated hardware implementation.

The electronic device 100 may also include instructions. The instructions may be implemented in a platform specific language that the processor 102 may decode and execute. The instructions may be stored in the memory 104 during execution. The instructions may include operations executable by the processor 102 to process user feedback to generate a product rating 112, according to the examples described herein.

In some examples, the import feedback instructions 106 may cause the processor 102 to import user feedback for a product from multiple websites. As used herein, a product may be a manufactured item. In some examples, a product may include a device. For instance, a product may include an electronic device such as a computing device (e.g., laptop computer, desktop computer, tablet computer, smartphone, gaming console, gaming controller, keyboard, mouse, computing accessory, etc.).

In some examples, a product may be grouped with similar products. For example, a product may be included in a product model (also referred tows model) and may be identified by a model number. For example, an individual computing device may be part of a given model of computing devices that are manufactured with the same or similar specifications. In other examples, the product may be part of a product line of items that are closely related.

In some examples, the websites may include third-party ecommerce websites that sell products to consumers. In some examples, the websites may be other websites that publish reviews of products. For example, news organization websites or social media websites may publish user feedback of products.

In some examples, the websites may provide a portal for receiving and publishing user feedback on a product. For example, users may post comments, reviews or user ratings based on a rating scale (e.g., star ratings) about a product on the websites.

In some examples, the user feedback may be in a text-based format. For example, users may type their user feedback into a graphical user interface. This text-based user feedback may then be stored and published by a website. In other examples, the user feedback may be in a numeric format (e.g., 1 out of 10 stars).

In some examples, the processor 102 may connect to the multiple websites and may import user feedback related to a product. For example, the processor 102 may query or search the websites for user feedback related to a given product. In some examples, this query may be performed through an application programming interface (API) that accepts search terms (e.g., product model name, model number, etc.) and returns user feedback that matches the criteria of the query. For example, the processor 102 may fetch historical user feedback for a given product or multiple products continuously from multiple websites hosting user feedback.

Some examples of APIs that may be used to acquire user feedback include RapidAPI and Yotpo UGC API. In an example for user feedback on Amazon®, Amazon Product/Reviews/keywords API may return user feedback about the products listen in Amazon. This API may provide user feedback based on the ASIN (Amazon Standard Identification Number).

In some examples, the processor 102 may extract the user feedback by scrapping content from the websites. In some examples, the web scrapping and web crawling may be controlled via programming scripts (e.g., Python scripts). The processor 102 may save the user feedback in a database or document (e.g., a spreadsheet). In some examples, the processor 102 may identify the imported user feedback with a product identifier (e.g., a model name, model number, etc.).

In some examples, the combine feedback instructions 108 may cause the processor 102 to combine the user feedback with product health data 114 for the product. In some examples, a database of product health data 114 may acquire and save information about the state of products. For example, in the case of computing devices, the product health data 114 may include information about the performance of the computing devices. In some examples, the computing devices may include an agent that sends product health data 114 on a periodic basis (e.g., daily, weekly, monthly, etc.). Therefore, the processor 102 may receive the product health data 114 for multiple electronic devices on a periodic basis. In some examples, the product health data 114 may be saved in memory 104 on the electronic device 100. In some examples, the product health data 114 may be saved in a remote database that the processor 102 may access over a network connection.

The product health data 114 received from a computing device may include identity information (e.g., product name, product number, model number, model name, serial number, etc.) to identify which electronic device generated the product health data 114.

In some examples, the product health data 114 may include hardware information (e.g., memory information, graphics information, processor information). In some examples, the product health data 114 may include operating system information, BIOS information, error information, data storage information, or other information related to the computing device. Additional examples of product health data 114 are provided in Table-1, described below.

The processor 102 may merge the user feedback with product health data 114. For example, the processor 102 may determine identity information for the product. The processor 102 may match the user feedback with the product health data based on the identity information. For example, both the user feedback and the product health data 114 may include identity information that the processor 102 uses to determine which user feedback is associated with which product health data 114.

The processor 102 may generate a combined feedback. For example, the processor 102 may combine the user feedback for a given product with the product health data 114 for that given product. In some examples, the combined feedback may be in the form of a spreadsheet or other data format.

In some examples, the processor 102 may generate a word cloud for the user feedback. In some examples, a word cloud may be a weighted list indicating the prominence of words in user feedback. For example, the processor 102 may indicate the frequency of terms in the user feedback. For example, the collected user feedback may be fed to a script (e.g., a Python script), which will convert the information to a word cloud.

In some examples, the user feedback may be refined using natural language processing. For example, a Matplotlib library along with a Word2Vec instructions may perform natural language processing of the user feedback.

In some examples, the ML model instructions 109 may cause the processor 102 run an ML model 110 to determine a rating 112 for the product based on the combined user feedback 108 and product health data 114. In some examples, the rating 112 output by the ML model 110 may be stored in memory 104. In some examples, the ML model 110 may be trained to predict whether user feedback is positive or negative based on pre-defined data dictionary. In some examples, the ML model 110 may process the user comments and may classify the user comments into two categories (e.g., positive or negative). Examples of a ML model 110 include support vector machines (SVMs), Long short-term memory (LSTM), k-nearest neighbors algorithm (k-NN), or neural network (e.g., convolutional neural network (CNN), recurrent neural network (RNN), etc.).

During training of the ML model 110, a training dataset may include a set of keywords that determine if the user feedback is positive or negative. This training dataset may then be used to train the ML model 110. In some examples, a 60-20-20 approach may be used to build the ML model 110. In this approach, 60% of the training dataset may be used for building the model, 20% of the training dataset may be used for validation of the ML model 110 and to rectify the ML model parameters, and 20% of the training dataset may be used to test the accuracy, recall and precision of the ML model 110.

In some examples, the ML model 110 may compare the user feedback to the product health data 114 to align the user feedback with actual performance of the product. For example, the ML model 110 may map user feedback to specific fields in the product health data 114. For example, if user feedback relates to batteries, the ML model 110 may map that user feedback to a battery field in the product health data 114. In this manner, the specific characteristics of a product may be related to the user feedback.

In some examples, responsive to predicting whether the user feedback is positive or negative, the ML model 110 may be trained to determine a rating 112 for the product. In some examples, the rating 112 may represent a summary of the positive and negative user feedback. In some examples, the rating 112 may be based on a ratio of positive to negative user feedback. For example, if 80% of the user feedback is positive and 20% of the user feedback is negative, then the rating 112 may be 8 out of 10, or 80%.

In some examples, the ML model instructions 109 may cause the processor 102 to run the ML model 110 to determine a number of top positive user feedback and a number of top negative user feedback for the product based on combined user feedback and product health data 114. In some examples, the rating 112 may be a summary of top positive user feedback and top negative user feedback. For example, the ML model 110 may process the user feedback to determine a number of top positive user feedback and a number of top negative user feedback. In some examples, the ML model 110 may classify the user feedback as either positive or negative. Once classified, the ML model 110 may then determine top positive and top negative user feedback based on the frequency of terms in the positive and negative user feedback. For example, if users frequently discuss the strengths of the battery, processor and memory of a computing device, these terms may be included in the top positive user feedback. If users frequently complain about graphics, aesthetics, and disk storage space for the computing device, then these terms may be included in the top negative user feedback.

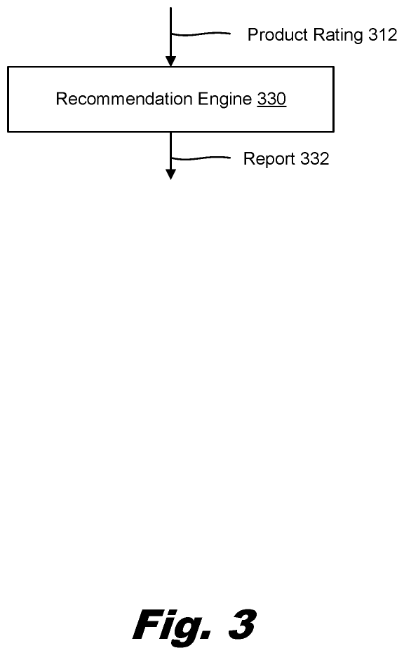

The rating 112 of the product based on the user feedback and product health data 114 may be used to provide insights to an end-user (e.g., a product development manager, a consumer, etc.). In some examples, report generation instructions (not shown) stored in the memory 104 may cause the processor 102 to generate a report based on the top positive user feedback and the top negative user feedback. In some examples, the processor 102 may implement a recommendation engine to generate a report based on the rating 112. The report may also include information about the top positive user feedback and the top negative user feedback. Examples of a recommendation engine are described in FIG. 3.

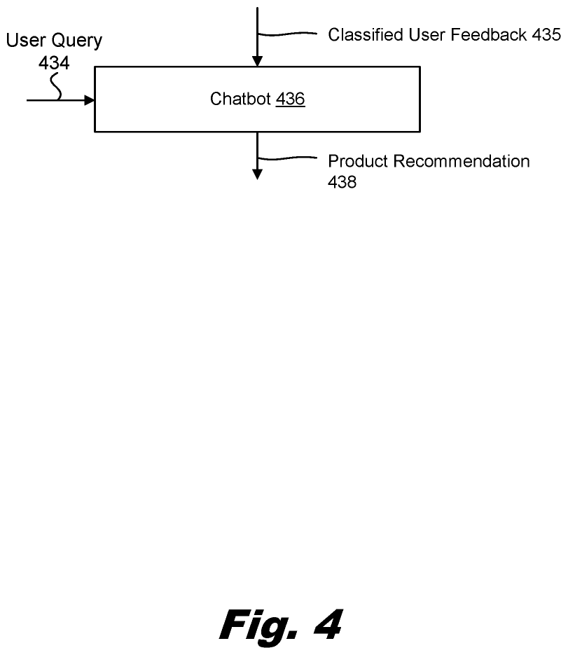

In some examples, the processor 102 may implement a chatbot to assist a customer in deciding what product best meets their indicated criteria. Examples of a chatbot that uses the user feedback and rating 112 are described in FIG. 4.

By rating a product based on user feedback, an organization may know how to direct development of a product. Furthermore, by continually monitoring user feedback, an organization may track changes in user sentiment as products are changed. Negative reviews are helpful as they indicate areas for further enhancement to offer a better product. Positive reviews may reinforce the strengths of the product.

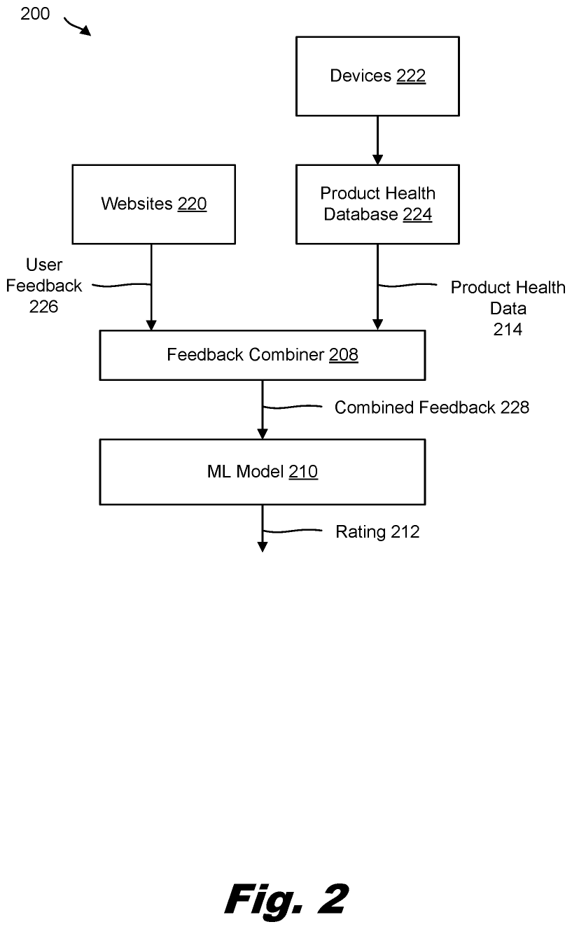

FIG. 2 is a block diagram illustrating a system 200 for generating a product rating based on user feedback 226, according to an example.

In some examples, user feedback 226 may be received from multiple websites 220. This user feedback 226 may be provided to a feedback combiner 208, as described in FIG. 1.

In some examples, multiple devices 222 may report their product health data 214 to a product health database 224. Examples of the product health data 214 that may be reported by the devices 222 are given in Table 1, where different data categories may have multiple fields. It should be noted that while several different examples of product health data 214 are included in Table 1, a computing device may report a subset of these examples, or other types of product health data 214.

TABLE 1

| Data Category | Field |
|---|---|
| Hardware Inventory | Device Type |
| | Device Manufacturer |
| | Device Model |
| | Operating System |
| | Operating System Release |
| | Operating System Build No |
| | Operating System Edition |
| | Operating System Type |
| | Product SKU |
| | Last Seen |
| | Memory |
| | Graphics |
| | Processor |
| | Manufacture Date |
| | Born On Date |
| | Enrolled Date |
| | Country |
| | Operating System Full |
| | TPM Version (Manufacturer Version) |
| BIOS | BIOS Manufacturer |
| | BIOS Version |
| | BIOS Status |
| | BIOS Release Date |
| | BIOS Installation Date |
| | Latest Version |
| | Latest Version Criticality |
| | Latest Version Release Notes |
| | Latest Version Software Package Number |
| | Latest Version Software Package Release Notes |
| | Latest Critical Available Version |
| | Latest Critical Available |
| Battery | Current Battery Health |
| | Recall status |
| | Battery SN |
| | Battery Warranty Status |
| | CT Number |
| Errors | Date Occurred |
| | Operating System |
| | OS Build Release |
| | OS Build No. |
| | Bug Check Code |
| | Bug Check Description |
| | Driver |
| | Date Occurred |
| | Operating System |
| | OS Build Release |
| | Driver Version |
| | Bug Check Parameter |
| Disk | Disk Serial Number |
| | Drive Type |
| | Disk Model |
| | Disk Capacity (GB) |
| | Disk Free (GB) |
| | Disk Firmware Version |
| Warranty & Care Packs | Warranty Status (Overall) |
| | Expiration Status (Overall) |
| | Days Remaining (Overall) |
| | Start Date (Overall) |
| | End Date (Overall) |
| | Offer Product ID |
| | Type |
| | Warranty Type |
| | Title |
| | Warranty Status |
| | Expiration Status |
| | Days Remaining |
| | Start Date |
| | End Date |
| Thermal | Thermal Condition |
| Display/Monitors | Display Type |
| | Display Model |
| | Status |
| Docking stations | Device Name |
| | Device Model |
| | Last Seen |
| | Status |
| Drivers | Operating System |
| | Operating System Release |
| | Operating System Build No. |
| | Operating System Type |
| | Driver Status |
| | Driver Category |
| | Driver Name |
| | Installed Driver Version |
| | Latest Driver Version |
| | Latest Driver Release Date |
| | Latest Driver Criticality |
| | Software Package Number |
| | Software Package Release Notes |
| | Hardware ID |
| | PnP Device ID |
| Software updates | Operating System |
| | Operating System Release |
| | Missing Update KB Code |
| | Missing Update Criticality |
| | Update Name |
| | Update Type |
| OS Startup/Shutdown | Operating System |
| Performance | Operating System Release |
| | Last Restart Date |
| | Event Type |
| | Current week performance (Minutes) |
| | Current week main path boot time (Minutes) |
| | Current week post on/off Boot time (Minutes) |
| | Current week slowdown reason |
| | Performance previous week(minutes) |
| | Performance two weeks ago(minutes) |

Upon receiving the product health data 214, the feedback combiner 208 may merge the user feedback 226 with the product health data 214. For example, the feedback combiner 208 may determine which user feedback corresponds with which product health data 214 based on a product identifier included in both the product health data 214 and the user feedback. The feedback combiner 208 may provide the combined feedback 228 to the ML model 210.

Upon receiving the combined feedback 228, the ML model 210 may predict if the user feedback 226 is positive or negative. In response to predicting whether the user feedback is positive or negative, the ML model 210 may determine a rating 212 for the product.

FIG. 3 is a block diagram illustrating a recommendation engine 330, according to an example. In some examples, the recommendation engine 330 may be implemented by a processor 102, as described in FIG. 1. For example, the processor may run an ML model to determine a number of top positive user feedback and a number of top negative user feedback for the product based on the combined user feedback and product health data. In some examples, the product rating 312 may include the top positive user feedback and the top negative user feedback.

In some examples, the recommendation engine 330 may generate a report 332 based on the top positive user feedback and the top negative user feedback. In some examples, the report 332 may include a product development recommendation based on the top positive user feedback and the top negative user feedback. The product development recommendation may indicate items to change based on the negative feedback and items that are successful based on the positive feedback.

In some examples, the recommendation engine 330 may determine a number (e.g., 3, 4, 5 etc.) of most liked features based on the top positive user feedback. The recommendation engine 330 may include the most liked features in the report 332. The recommendation engine 330 may determine development recommendations based on the top negative user feedback. The recommendation engine 330 may include a number (e.g., 3, 4, 5, etc.) of development recommendations in the report 332.

In some examples, the recommendation engine 330 may generate analytic data for trend analysis of the product based on the product rating 312, the user feedback and the product health data. For example, the analytic data may show trends in user feedback that is correlated with the product health data. The product rating 312 may indicate the success or lack of success of product development based on the user feedback. The recommendation engine 330 may include the analytic data in the report 332.

In some examples, the report 332 may be sent as an email. For example, an email may be sent to a product development manager. In some examples, the report 332 may be sent on a periodic basis (e.g., weekly) based on updated user feedback.

FIG. 4 is a block diagram illustrating a chatbot 330, according to an example. In some examples, the chatbot 330 may be implemented by a processor 102, as described in FIG. 1. For example, the processor may receive user feedback for multiple products from multiple websites. The processor may also receive product health data for the multiple products. The processor may then run an ML model to classify the user feedback for the multiple products based on the user feedback and product health data. The classified user feedback 435 may be classified as positive or negative feedback. The classified user feedback 435 may also include a rating for each of the multiple products.

The processor may implement a chatbot 436 to generate a product recommendation 438 based on the classified user feedback 435. For example, the chatbot 436 may receive a user query 434. In some examples, the chatbot 436 may interact with the user through a web browser or other user interface. In some examples, the user query 434 may indicate criteria for a product that a user is interested in purchasing or using. In some examples, the user query 434 may include shopping criteria. For instance, a user may indicate a type of computing device (e.g., laptop computer) and a price range.

The chatbot 436 may generate the product recommendation 438 based on the user query and the classified user feedback 435. For example, the chatbot 436 may provide a number of recommended products to meet the user query 434 based on the classified user feedback 435. In some examples, the chatbot 436 may determine multiple products that meet the user query 434. The chatbot 436 may then filter the multiple products according to the classified user feedback 435. For example, the chatbot 436 may present a number of top products to the user based on which products have the top ratings in the classified user feedback 435.

In some examples, the chatbot 436 may perform comparative shopping. For example, comparative shopping provides users (e.g., customers) the ability to compare prices on products across different retailers. The user may choose a store where the product is cheapest. For consumers, comparison shopping engines have become a valuable source of information in the buying decision process. The chatbot 436 may enable consumers to compare different offers based on technical characteristics and price so the consumer may make the best shopping decisions.

In some examples, a user may become overwhelmed after comparing two or three products. The user may then make a decision based on their instinct, which might lead to a wrong decision. To address this scenario, the chatbot 436 may suggest the best products to meet the user query 434. For example, a user may want to buy a gaming laptop, but does not know whether to pick computer A or computer B. The chatbot 436 may help the user choose a particular computer by suggesting the best computer based on the classified user feedback 435, technical specifications and cost of the different computers.

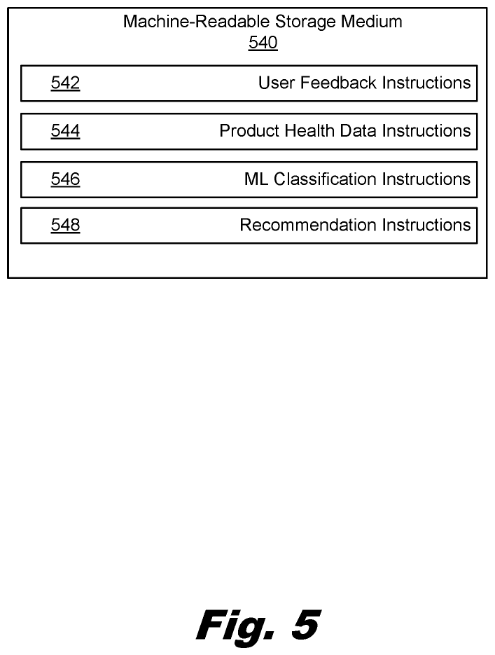

FIG. 5 depicts a non-transitory machine-readable storage medium 540 for generating a product recommendation based on classified user feedback, according to an example. To achieve its desired functionality, an electronic device 100 includes various hardware components. Specifically, an electronic device includes a processor and a machine-readable storage medium 540. The machine-readable storage medium 540 is communicatively coupled to the processor. The machine-readable storage medium 540 includes a number of instructions 542, 544, 546, 548 for performing a designated function. The machine-readable storage medium 540 causes the processor to execute the designated function of the instructions 542, 544, 546, 548. The machine-readable storage medium 540 can store data, programs, instructions, or any other machine-readable data that can be utilized to operate the electronic device 100. Machine-readable storage medium 540 can store computer readable instructions that the processor of the electronic device 100 can process or execute. The machine-readable storage medium 540 can be an electronic, magnetic, optical, or other physical storage device that contains or stores executable instructions. Machine-readable storage medium 540 may be, for example, Random Access Memory (RAM), an Electrically Erasable Programmable Read-Only Memory (EEPROM), a storage device, an optical disc, etc. The machine-readable storage medium 540 may be a non-transitory machine-readable storage medium 540, where the term “non-transitory” does not encompass transitory propagating signals.

Referring to FIG. 5, user feedback instructions 542, when executed by the processor, may cause the processor to receive user feedback for multiple products from multiple websites. Product health data instructions 544, when executed by the processor, may cause the processor to receive product health data for the multiple products. ML classification instructions 546, when executed by the processor, may cause the processor to run an ML model to classify the user feedback for the multiple products based on the user feedback and product health data. Recommendation instructions 548, when executed by the processor, may cause the processor to generate a product recommendation based on the classified user feedback.

In some examples, the processor may implement a chatbot to receive a user query. In some examples, the user query may include shopping criteria. The chatbot may generate the product recommendation based on the user query and the classified user feedback. The chatbot may provide the product recommendation to the user. For example, the chatbot may provide a number of recommended products to meet the user query based on the classified user feedback.

What is claimed is:

1. An electronic device, comprising:
a processor; and
a memory communicatively coupled to the processor and storing executable instructions that when executed cause the processor to:
import user feedback for a product from multiple websites;
combine the user feedback with product health data for the product; and
run a machine-learning (ML) model to determine a rating for the product based on the combined user feedback and product health data.

2. The electronic device of claim 1, wherein the executable instructions further comprise executable instructions to cause the processor to:
receive the product health data for multiple electronic devices on a periodic basis.

3. The electronic device of claim 1, wherein the website comprises a third-party ecommerce website.

4. The electronic device of claim 1, wherein the executable instructions to combine the user feedback with product health data comprise executable instructions to cause the processor to:
determine identity information for the product; and
match the user feedback with the product health data based on the identity information.

5. The electronic device of claim 1, wherein the ML model is to predict if the user feedback is positive or negative.

6. The electronic device of claim 5, wherein, responsive to predicting whether the user feedback is positive or negative, the ML model is to determine the rating for the product based on a data dictionary.

7. An electronic device, comprising:
a processor; and
a memory communicatively coupled to the processor and storing executable instructions that when executed cause the processor to:
import user feedback for a product from a website;
combine the user feedback with product health data for the product;
run a machine-learning (ML) model to determine a number of top positive user feedback and a number of top negative user feedback for the product based on the combined user feedback and product health data; and
generate a report based on the top positive user feedback and the top negative user feedback.

8. The electronic device of claim 7, wherein the executable instructions further comprise executable instructions to cause the processor to:
generate a product development recommendation based on the top positive user reviews and the top negative user reviews; and
include the product development recommendation in the report.

9. The electronic device of claim 7, wherein the executable instructions further comprise executable instructions to cause the processor to:
determine a number of most liked features based on the top positive user reviews; and
include the most liked features in the report.

10. The electronic device of claim 7, wherein the executable instructions further comprise executable instructions to cause the processor to:
determine development recommendations based on the top negative user reviews; and
include the development recommendations in the report.

11. The electronic device of claim 7, wherein the executable instructions further comprise executable instructions to cause the processor to;
generate analytic data for trend analysis of the product; and
include the analytic data in the report.

12. A non-transitory computer readable medium comprising machine readable instructions that when executed cause a processor to:
receive user feedback for multiple products from multiple websites;
receive product health data for the multiple products; and
run a machine-learning (ML) model to classify the user feedback for the multiple products based on the user feedback and product health data; and
generate a product recommendation based on the classified user feedback.

13. The compute readable medium of claim 12, wherein the instructions to generate the product recommendation comprise instructions that when executed cause the processor to:
receive a user query; and
generate the product recommendation based on the user query and the classified user feedback.

14. The computer readable medium of claim 13, wherein the instructions to generate the product recommendation comprise instructions that when executed cause the processor to:
implement a chatbot to receive the user query and provide the product recommendation.

15. The computer readable medium of claim 13, wherein the instructions to generate the product recommendation comprise instructions that when executed cause the processor to:
provide a number of recommended products to meet the user query based on the classified user feedback, wherein the user query comprises shopping criteria.
